(19) United States
(12) Patent Application Publication
(10) Pub. No.: US 2004/0080156 A1
(43) Pub. Date: Apr. 29, 2004

(54) Common rail for diesel engines

(75) Inventor: Masayoshi Usui, Shizuoka (JP)

Correspondence Address: CASELLA & HESPOS, 274 MADISON AVENUE, NEW YORK, NY, 10016

(73) Assignee: Usui Kokusai Sangyo Kaisha Limited, Sunto-gun (JP)

(21) Appl. No.: 10/653,477

(22) Filed: Sep. 2, 2003

(30) Foreign Application Priority Data
Sep. 2, 2002 (JP) 2002-256332

(51) Int. Cl. F16L 39/00

(52) U.S. Cl. 285/133.11

(57) ABSTRACT

A common rail, in which a flow passage in a main pipe rail and portions of branch holes are improved in durability while the portions of branch holes are enhanced in fatigue strength for inner pressures, is provided. A common rail for diesel engines, comprising branch holes made in a main pipe rail having therein a flow passage in an axial direction, to be communicated to the flow passage, wherein stress concentration in the vicinity of the branch holes is relaxed, and then a whole inner peripheral surface of the main pipe rail and the branch holes are subjected to autofrettage processing.

### BACKGROUND OF THE INVENTION

1. Field of the Invention

The present invention relates to a common rail, such as high-pressure fuel manifolds, block rails, or the like, in a fuel injection system for diesel engines, and more particularly, to a common rail for diesel engines, in which portions of a branch hole or holes on a main pipe rail and a whole inner peripheral surface of the main pipe rail are enhanced in fatigue strength for inner pressures.

2. Description of the Prior Arts

Known as a common rail in a fuel injection system for diesel engines is a configuration, in which, for example, as shown in FIG. 7, a branch hole 11-2 provided in a peripheral wall of a main pipe 11 made of a circular pipe to be communicated to an internal flow passage 11-1 leads to an outwardly opened pressure-receiving seat surface 11-3, a cylindrical-shaped sleeve nipple 13 is mounted on an outer peripheral wall of the main pipe 11 in the vicinity of the pressure-receiving seat surface as by welding or brazing, a pressing seat surface 12-3 of a connection head 12-2 on a branch pipe 12 is caused to abut against and engage with the pressure-receiving seat surface 11-3 of the main pipe 11, and connection is achieved by clamping according to pressing below a neck of the connection head 12-2, caused by screwing between the sleeve nipple 13 and a clamping nut 14 beforehand assembled to the branch pipe. In the figure, the reference numeral 12-1 denotes a flow passage in the branch pipe 12.

However, the common rail of this kind involves the possibility that a large stress is generated at an inner peripheral edge P of a lower end of the branch hole 11-2 due to inner pressure in the main pipe 11 and axial forces applied to the pressure-receiving seat surface 11-3 according to pressing of the connection head 12-2 of the branch pipe 12, and so crack is liable to generate with the inner peripheral edge P as a starting point to cause leakage.

The inventors of the present application has proposed, as a countermeasure for the above, a common rail, in which a maximum stress value generated at an inner peripheral edge P of a lower end of a branch hole is decreased and fatigue strength for inner pressures is enhanced.

For example, (1) a common rail increased in fatigue strength for inner pressures, in which stress concentration generated at the inner peripheral edge of the lower end of the branch hole is relaxed by forming a portion, which is flattened, by a pressing method, on an inner peripheral surface of a main pipe toward a branch hole (see JP-A-10-246168), and (2) a common rail increased in fatigue strength for inner pressures, in which compressive residual stresses are made present in and around an end of the branch hole opened to a flow passage of the main pipe to thereby cancel a tensile stress generated at the inner peripheral edge of the lower end of the branch hole by high inner pressures in the main pipe (see JP-A-10-306757, JP-A-10-318081, JP-A-10-318082, JP-A-10-318083, JP-A-10-318086, and so on). In addition, adopted as the method of making compressive residual stresses present in and around an end of the branch hole opened to a flow passage in the main pipe is a method of applying pressing forces by means of a press system or the like, a method of applying pressure in a flow passage in a main pipe, a pipe expanding method of mechanically applying pressing forces from an interior of a main pipe in a diametrical direction of the pipe, a diameter expanding method of mechanically applying pressing forces from an interior of a branch pipe in a diametrical direction of the pipe, or the like. Further, proposed are (3) a common rail increased in fatigue strength for inner pressures, in which stress concentration generated at an inner peripheral edge of a lower end of a branch hole is relaxed by inserting a branch pipe or a branch joint deeply into a branch hole, and fixing the pipe or joint with a tip end of the pipe or joint projecting into an interior of a flow passage from an inner peripheral wall surface of a main pipe rail (Japanese Patent Application No. 2001-387366), and (4) a common rail increased in fatigue strength for inner pressures, in which stress concentration generated at an inner peripheral edge of a lower end of a branch hole is relaxed by providing a flattened surface on an end of a branch hole opened to a flow passage of a main pipe rail and fixing the branch pipe in a state, in which the branch pipe projects into the flow passage from the flattened surface (Japanese Patent Application No. 2001-11772).

However, the common rails have been previously proposed by the inventors of the present application involve the following matters described below and to be improved.

More specifically, with (1) a common rail increased in fatigue strength for inner pressures, in which stress concentration generated at the inner peripheral edge of the lower end of the branch hole is relaxed by forming a portion, which is flattened, by a pressing method, on an inner peripheral surface of a main pipe toward a branch hole and (2) a common rail increased in fatigue strength for inner pressures, in which compressive residual stresses are made present in and around an end of the branch hole opened to a flow passage of the main pipe to thereby cancel a tensile stress generated at the inner peripheral edge of the lower end of the branch hole by high inner pressures in the main pipe, the countermeasure takes effect on the flattened portion or a portion, in which stress is residual, but does not take any adequate effect on other portions than these portions, that is, the flow passage of the main pipe or a flow passage of the branch hole. Also, with (3) and (4), in which the branch pipe is made to project into the interior of the flow passage beyond the inner peripheral wall surface of the main pipe rail, stress concentration at corner portions of the flow passage in the branch hole is dissolved but degradation in fatigue strength for inner pressures is unavoidable since brazing is necessary in order to carry out the techniques (3), (4) and portions applied by such thermal influences are necessarily degraded in strength.

Meanwhile, while a set pressure for common rails in a fuel system for diesel engines has been conventionally around 135 Mpa, pressure as high as 160 Mpa presently tends to be the main stream and common rails for 180 Mpa are further being developed for the future. Correspondingly, strength required for common rails must be able to include pulsation and to conform to +20 Mpa, and it is expected that common rails usable at 200 Mpa (180 Mpa+20 Mpa) will be needed in the near future.

The invention has been thought of in order to solve the above-mentioned problems and accommodate to systems with a high set pressure of around 200 Mpa, and has its object to provide a common rail, in which a flow passage in a main pipe rail and portions of a branch hole are improved in durability while the portions of the branch hole are enhanced in fatigue strength for inner pressures.

### SUMMARY OF THE INVENTION

In order to attain the above object, a common rail for diesel engines according to the invention, in which a branch hole is made in a main pipe rail, having therein a flow passage in an axial direction, to be communicated to the flow passage, has a feature in that stress concentration in the vicinity of inner peripheral edges of openings of the branch holes is relaxed, and then a whole inner peripheral surface of the main pipe rail and the branch holes are subjected to autofrettage processing, a feature in that at least neighborhoods of openings of the branch holes are flattened to relax stress concentration, and then a whole inner peripheral surface of the main pipe rail and the branch holes are subjected to autofrettage processing, a feature in that pressing forces are applied to neighborhoods of ends of the branch holes opened to the main pipe rail to leave compressive residual stresses in the neighborhoods of openings of the branch holes to relax stress concentration, and then a whole inner peripheral surface of the main pipe rail and the branch holes are subjected to autofrettage processing, and a feature in that stress concentration in the vicinity of the branch holes is relaxed by inserting tip ends of branch pipes deeply into the branch holes beyond an inner peripheral surface of the main pipe rail up to an interior of the flow passage and firmly connecting the branch pipes to the main pipe rail, and then a whole inner peripheral surface of the main pipe rail and interiors of connections of the branch holes are subjected to autofrettage processing. Here, autofrettage processing means application of stresses by exerting pressing forces on a pipe by means of an internal pressure system.

It is well known that when the autofrettage processing is applied on a thick-wall pipe, compressive residual stresses are generated and an improvement in fatigue strength for inner pressures is resulted. In common rails for diesel engines, however, the following disadvantages are caused when autofrettage is applied without application of the processings in the conventional (1) to (4) to a stock pipe.

For example, in the case where a branch hole of 0.3 mm is made in a main pipe which has an outside diameter of 24 m/m, inside diameter of 7 m/m, pipe tensile strength Ts=650 Mpa, and yielding point Yp=450 Mpa and in which a circumferential stress on an inner surface amounts to 240 Mpa upon application of internal pressure of 100 Mpa, a maximum tensile stress at an opening peripheral edge of the branch hole in a circumferential direction of the inner surface results in stress concentration of 531 Mpa (2.6 times 240 Mpa).

Meanwhile, in the case where pressure at which the autofrettage processing is applied amounts to pressure, at which a portion of the main pipe as far as a center of wall thickness is subjected to plastic deformation, an internal pressure of 350 Mpa is needed according to a stress calculating formula (Tresca's formula). When the pressure of the autofrettage processing is applied, a location of stress concentration at the opening peripheral edge of the branch hole is exerted by the same load as 2.6 times the pressure on other portions. More specifically, it can be readily estimated that the location of stress concentration at the opening peripheral edge of the branch hole is put in the same state as that when pressure of 910 Mpa, that is, 2.6 times 240 Mpa is applied, and suffers crack.

On the other hand, in the case where pressure is selected to leave compressive residual stresses at the location of stress concentration, a stress generated becomes 2.6 times 350 Mpa, so that a value obtained by dividing 350 Mpa by 2.6, that is, 134.6 Mpa can be selected. It is shown that the value is lower than a demanded working pressure 160 Mpa and use is not possible at a pressure above 134.6 Mpa.

As can be deduced from the above description, pressure, at which a suitable residual stress is obtained, is not present in either of the case where the flow passage in the main pipe is aimed at, and the case where the location of stress concentration is aimed at. From the above, there is a need of relaxing stress concentration in order that autofrettage is used to leave compressive residual stresses on inner surfaces of all flow passages in the main pipe and the branch hole.

According to the invention, since the processing of any one of the (1) to (4) or a combination thereof is carried out, and then autofrettage pressure of, for example, 350 Mpa is applied, compressive stresses of about 399 Mpa are left in the flow passage in the main pipe (according to Tresca's formula). Meanwhile, since stresses are not concentrated or relaxed at the portion of the branch hole, residual stresses of 399 Mpa or therearound can be expected.

As described above, since stress concentration at the peripheral edge of the branch hole is relaxed and autofrettage is then applied according to the invention, high compressive residual stresses due to the synergistic effect of relaxation of stress concentration applied at the peripheral edge of the branch hole and autofrettage applied on the whole flow passage in the main pipe rail and the flow passage in the branch hole can be made present in the whole common rail, and an excellent durability can be expected also for the flow passage in the main pipe rail and the opening peripheral edge of the branch hole while fatigue strength for inner pressures is increased at the inner peripheral edge of the lower end of the branch hole.

### BRIEF DESCRIPTION OF THE DRAWINGS

FIG. 1 is a partially enlarged, cross sectional view showing a first embodiment of a common rail for diesel engines, according to the invention;

FIG. 2 is a longitudinal, cross sectional view of FIG. 1;

FIG. 3 is a partially enlarged, cross sectional view showing a second embodiment of the invention;

FIG. 4 is a longitudinal, cross sectional view of FIG. 3;

FIG. 5 is a partially enlarged, cross sectional view showing a third embodiment of the invention;

FIG. 6 is a partially enlarged, cross sectional view showing a fourth embodiment of the invention;

FIG. 7 is a longitudinal, cross sectional view showing a first example of a conventional common rail for diesel engines;

FIG. 8 is a longitudinal, cross sectional view showing a second example of a conventional common rail for diesel engines;

FIG. 9 is a longitudinal, cross sectional view showing a third example of a conventional common rail for diesel engines;

FIG. 10 is a longitudinal, cross sectional view showing a fourth example of a conventional common rail for diesel engines; and

FIG. 11 is a longitudinal, cross sectional view showing a fifth example of a conventional common rail for diesel engines.

### DETAILED DESCRIPTION OF THE PREFERRED EMBODIMENTS

In the invention, reference numeral 1 denotes a main pipe rail, 1-1 a flow passage, 1-2 a branch hole, 1-3 a pressure-receiving seat surface, 1-4 a boss portion, 1-4a a male thread, 1-5 a flattened surface, 2 a branch pipe, 2-1 a flow passage, and 2-2 a projection.

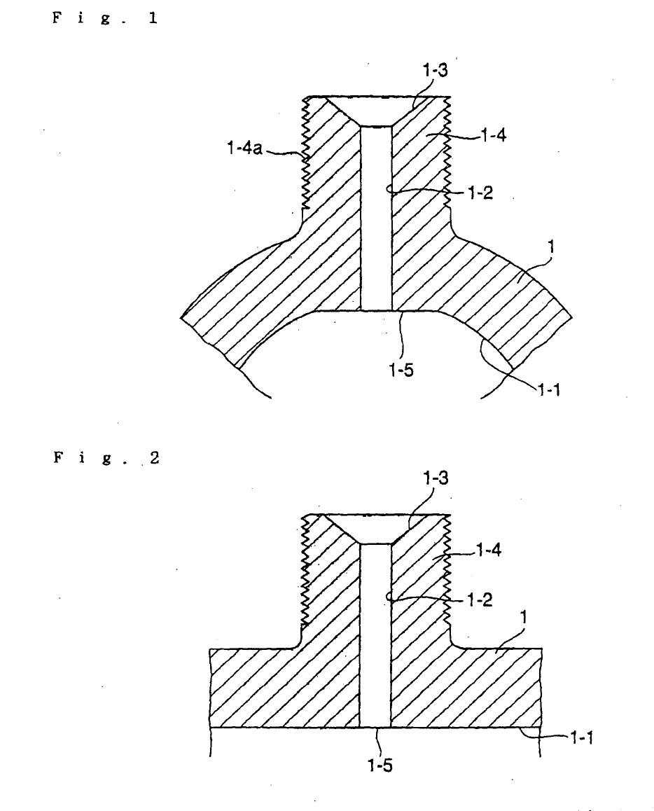

A main pipe rail 1 as a common rail shown in FIGS. 1 to 4 is a forging of a material S45C or the like and has a tubular portion, which is relatively thick-walled to have, for example, a diameter of 28 mm and a wall thickness 9 mm and in which an axial interior is subjected to machining such as boring, gun drilling, or the like to make a flow passage 1-1, and a plurality of boss portions 1-4 are provided on a peripheral wall to be axially spaced from one another.

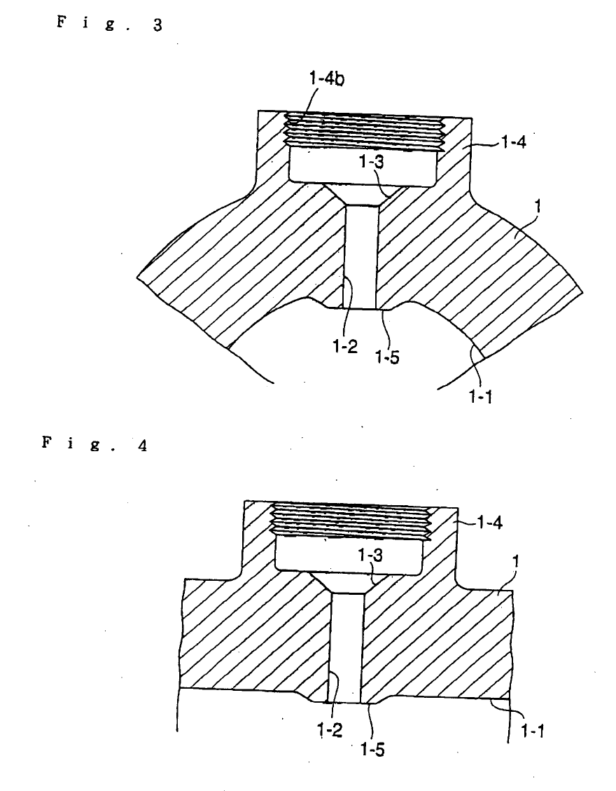

In the common rail shown in FIGS. 1 and 2, branch holes 1-2 having a predetermined diameter are formed in the boss portions 1-4 integral with the main pipe rail 1 to be communicated to the flow passage 1-1 of the main pipe rail, pressure-receiving seat surfaces 1-3 which are conical in shape and are opened outward are formed at the outward opening ends of the branch holes 1-2, and male threads 1-4a are worked on outer peripheries of the boss portions 1-4. The pressing method or the like is used to form flattened surfaces 1-5 on an inner peripheral surface of the main pipe rail 1 toward the branch holes 1-2, preferably over the whole axial length, and on at least peripheral edges of openings of the branch holes 1-2, whereby stress concentration generated at inner peripheral edges of lower ends of the branch holes 1-2 is relaxed to increase inner pressure strength at the inner peripheral edges of the lower ends of the branch holes, and then autofrettage processing is applied to generate compressive residual stresses on the whole inner peripheral surface of the main pipe rail 1 and all of the branch holes 1-2, thereby increasing the fatigue strength for inner pressures.

As a method of forming the flattened surfaces 1-5, it is possible to adopt a method of applying pressing forces by means of, for example, an external pressure system to form flattened surfaces on an inner peripheral wall surface, a method of forming flattened surfaces on an inner peripheral wall surface at the time of forging, a method of forming flattened surfaces at the time of extrusion molding, and so on. Incidentally, with the method of applying pressing forces by means of an external pressure system to form flattened surfaces on an inner peripheral wall surface, the flattened surfaces include, in some cases inwardly projecting arcuate surfaces. Accordingly, the flattened surfaces referred to in the invention are not completely flat surfaces but include various curved configurations such as the arcuate surfaces, elliptical-shaped surfaces, or the like.

Also, the autofrettage processing is a process in which pressing forces produced by a fluid pressure are applied to the flow passage in the main pipe rail 1 to exert stresses on the whole inner peripheral surface of the main pipe rail 1 and in the branch holes 1-2.

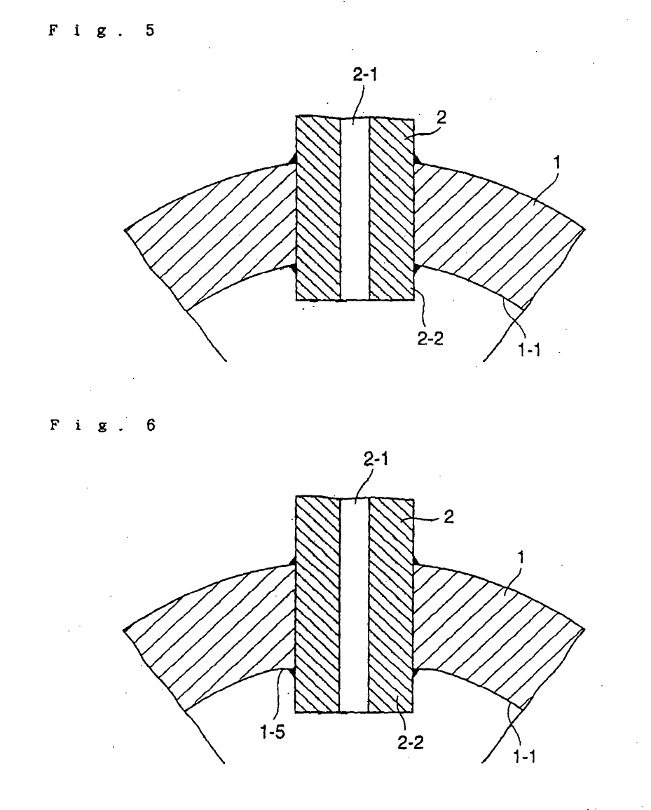

Subsequently, with a common rail shown in FIGS. 3 and 4, branch holes 1-2 having a predetermined diameter are formed in boss portions 1-4 integral with a main pipe rail 1 to be communicated to a flow passage 1-1 of the main pipe rail, pressure-receiving seat surfaces 1-3 which are conical in shape and are opened outward are formed at the outward opening ends of the branch holes 1-2 and female threads 1-4b are worked on inner peripheries of the boss portions 1-4. The pressing method or the like is used to project a side of an inner peripheral surface of the main pipe rail 1 toward the branch holes 1-2 to make flattened surfaces 1-5 only in the vicinity of the branch holes whereby compressive residual stresses are generated at inner peripheral edges of lower ends of the branch holes 1-2 to increase inner pressure strength at the inner peripheral edges of the lower ends of the branch holes, and the autofrettage processing is then applied to generate compressive residual stresses on the whole inner peripheral surface of the main pipe rail 1 and all of the branch holes 1-2, thereby increasing the fatigue strength for inner pressures.

As a method of projecting only neighborhoods of the branch holes 1-2 to make flattened surfaces 1-5 in the common rail shown in FIGS. 3 and 4, it is possible to adopt a method of using a pressing system with, for example, punches, rods, or the like to press a thick-walled portion of a main pipe rail diametrically inward to project the flow passage 1-1 side so as to make the same substantially circular and at least flat. In addition, that surface, which is caused by the projecting method to project inward, includes not only a flat surface but also various curved configurations such as arcuate surfaces, elliptical-shaped surfaces, or the like, and spherical configurations.

Also, with a common rail shown in FIG. 5, stress concentration generated at an inner peripheral edge of a lower end of a branch hole is relaxed and fatigue strength for inner pressures is increased by inserting a branch pipe 2 (or a branch joint) deeply into a branch hole 1-2 and projecting a tip end of the branch pipe into a flow passage 1-1 from an inner peripheral surface of a main pipe rail 1 to fix the same by means of brazing, and further the autofrettage processing is applied to generate compressive residual stresses on the whole inner peripheral surface of the main pipe rail 1 and the whole branch hole 1-2, thereby increasing the fatigue strength for inner pressures.

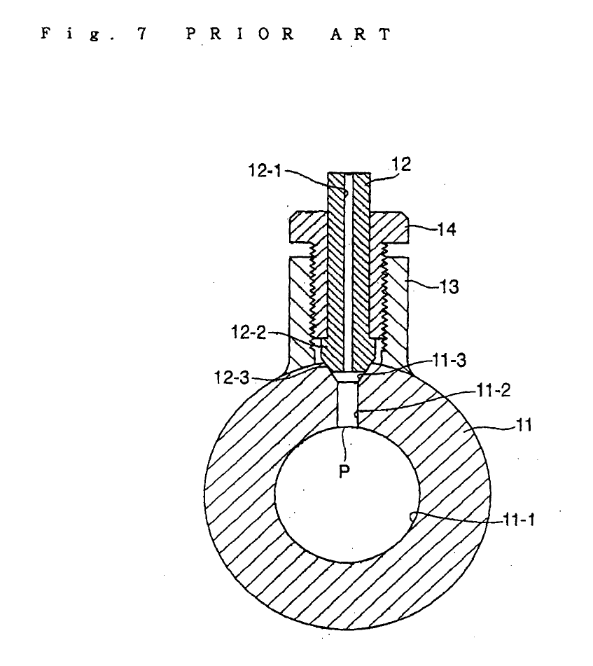

Further, with a common rail shown in FIG. 6, flattened surfaces 1-5 are provided at ends of branch holes 1-2 opened to a flow passage of a main pipe rail 1 and branch pipes 2 (or branch joints) are projected into the flow passage 1-1 from the flattened surfaces 1-5 to be subjected to brazing, whereby stress concentration generated at inner peripheral edges of lower ends of the branch holes 1-2 is relaxed to increase inner pressure strength, and the autofrettage processing is then applied in the same manner described above to generate compressive residual stresses on the whole inner peripheral surface of the main pipe rail 1 and all of the branch holes 1-2, thereby increasing the fatigue strength for inner pressures.

TABLE 2 indicates results of an endurance test carried out by the use of common rails (steel type: S45C) shown in TABLE 1. In the present embodiment, the endurance test was carried out, in which test pressures composed of a base pressure 18 Mpa and peak pressures 140 to 230 Mpa were applied to respective common rails.

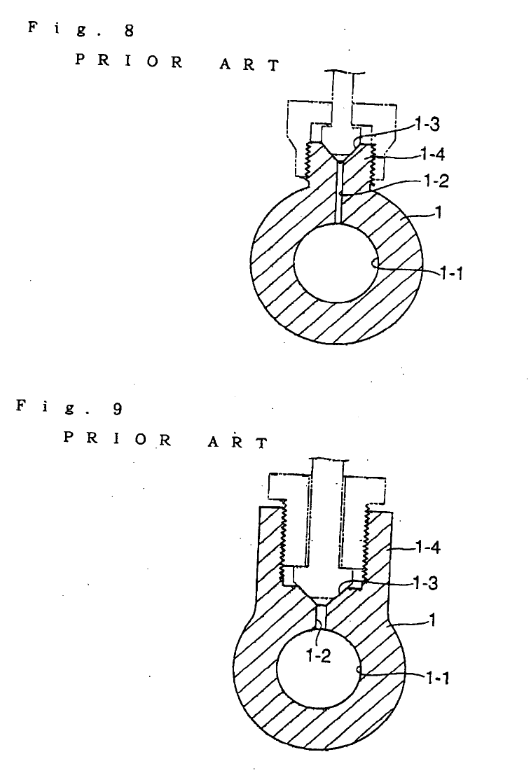

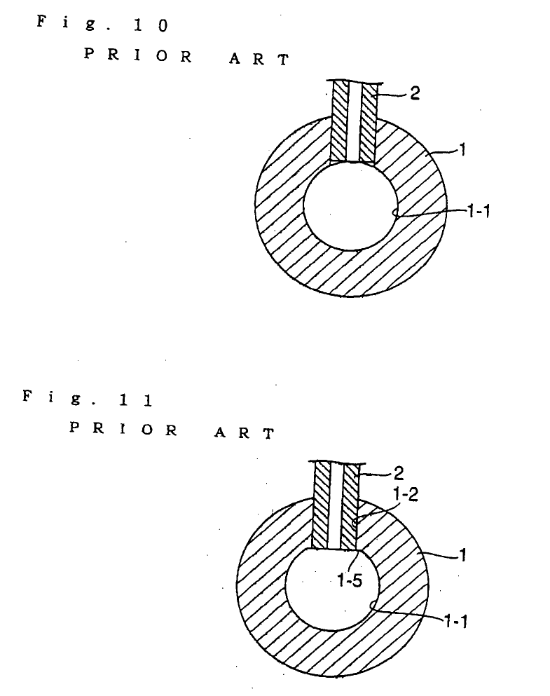

In addition, FIG. 8 shows a common rail, which is the same kind as those shown in FIGS. 1 and 2 and in which a cross section of a flow passage 1-1 of a main pipe rail 1 assumes a perfect circle, FIG. 9 shows a common rail, which is the same kind as those shown in FIGS. 3 and 4 and in which a cross section of a flow passage 1-1 of a main pipe rail 1 assumes a perfect circle in the same manner as the common rail shown in FIG. 8, FIG. 10 shows a common rail, which corresponds to the common rail shown in FIG. 5 and in which brazing is performed without having a tip end of a branch pipe 2 projected into a flow passage 1-1 of a main pipe rail 1, and FIG. 11 shows a common rail, which corresponds to the common rail shown in FIG. 6 and in which brazing is performed without having a tip end of a branch pipe 2 projected from a flattened surface 1-5, which is provided at an end of a branch hole 1-2 opened to a flow passage 1-1 of a main pipe rail 1.

It is found from the results in TABLE 2 that all the common rails according to the invention exhibit an excellent fatigue strength for inner pressures.

TABLE 1

| | SIZE | | |
|---|---|---|---|
| TYPE | MAIN PIPE RAIL | | BRANCH HOLE |
| A (FIG. 1, FIG. 8) | DIAMETER | 24 mm | DIAMETER |
| | INSIDE DIAMETER | 10 m | 3 mm |
| B (FIG. 3, FIG. 9) | DIAMETER | 24 mm | DIAMETER |
| | INSIDE DIAMETER | 10 m | 3 mm |
| C (FIG. 5, FIG. 10) | DIAMETER | 24 mm | DIAMETER |
| | INSIDE DIAMETER | 10 m | 3 mm |
| D (FIG. 6, FlG. 11) | DIAMETER | 24 mm | DIAMETER |
| | INSIDE DIAMETER | 10 m | 3 mm |

TABLE 2

| | | Yes or no of | | | |
|---|---|---|---|---|---|
| | | relaxation | | | |
| | | processing of | | | |
| | | stress | Autogrettage | Pressure fatigue | Results of |
| Type | Material for test | concentration | pressure | pressure | test |
| A | Invention 1 | Yes | 350 | 18 to 230 | 10⁷ Pass |
| | (FIG. 1) | | | | |
| | Comparative example 1 | No | 350 | 18 to 160 | Rupture |
| | (FIG. 8) | | | | |
| | Comparative example 2 | No | NO | 18 to 160 | Rupture |
| | (FIG. 8) | | | | |
| B | Invention 2 | Yes | 350 | 18 to 230 | 10⁷ Pass |
| | (FIG. 3) | | | | |
| | Comparative example 3 | No | 350 | 18 to 160 | Rupture |
| | (FIG. 9) | | | | |
| | Comparative example 4 | No | NO | 18 to 160 | Rupture |
| | (FIG. 9) | | | | |
| C | Invention 3 | Yes | 300 | 18 to 190 | 10⁷ Pass |
| | (FIG. 5) | | | | |
| | Comparative example 5 | Yes | NO | 18 to 190 | Rupture |
| | (FIG. 5) | | | | |
| | Comparative example 6 | No | NO | 18 to 140 | Rupture |
| | (FIG. 10) | | | | |
| D | Invention 4 | Yes | 300 | 18 to 200 | 10⁷ Pass |
| | (FIG. 6) | | | | |
| | Comparative example 7 | Yes | NO | 18 to 190 | Rupture |
| | (FIG. 6) | | | | |
| | Comparative example 8 | Yes | NO | 18 to 150 | Rupture |
| | (FIG. 11) | | | | |

As described above, a common rail for diesel engines, according to the invention, demonstrates a remarkable effect that an excellent durability can be expected for a flow passage in a main pipe rail and portions of a branch holes while fatigue strength for inner pressures is increased at inner peripheral edges of lower ends of the branch holes, since stress concentration at peripheral edges of the branch holes is relaxed and autofrettage is then applied whereby high compressive residual stresses due to the synergistic effect of relaxation of stress concentration applied at the peripheral edges of the branch holes and autofrettage applied on the whole flow passage in the main pipe rail and flow passages in the branch holes can be made present in the whole common rail.

1. A common rail for diesel engines, comprising branch holes made in a main pipe rail, having therein a flow passage in an axial direction, to be communicated to the flow passage, wherein stress concentration in the vicinity of inner peripheral edges of openings of the branch holes is relaxed, and then a whole inner peripheral surface of the main pipe rail and the branch holes are subjected to autofrettage processing.

2. The common rail for diesel engines, according to claim 1, wherein the main pipe rail comprises a forging made of a material S45C and having a thick-walled tubular portion.

3. The common rail for diesel engines, according to claim 1, wherein at least peripheral edges of openings of the branch holes are formed with flattened surfaces.

4. The common rail for diesel engines, according to claim 1, wherein branch holes having a predetermined diameter are made in boss portions integral with the main pipe rail to communicated to the flow passage in the main pipe rail.

5. A common rail for diesel engines, comprising branch holes made in a main pipe rail, having therein a flow passage in an axial direction, to be communicated to the flow passage, wherein at least neighborhoods of openings of the branch holes are flattened to relax stress concentration, and then a whole inner peripheral surface of the main pipe rail and the branch holes are subjected to autofrettage processing.

6. The common rail for diesel engines, according to claim 5, wherein the main pipe rail comprises a forging made of a material S45C and having a thick-walled tubular portion.

7. The common rail for diesel engines, according to claim 5, wherein at least peripheral edges of openings of the branch holes are formed with flattened surfaces.

8. The common rail for diesel engines, according to claim 5, wherein branch holes having a predetermined diameter are made in boss portions integral with the main pipe rail to be communicated to the flow passage in the main pipe rail.

9. A common rail for diesel engines, comprising branch holes made in a main pipe rail having therein a flow passage in an axial direction, to be communicated to the flow passage, wherein pressing forces are applied to neighborhoods of ends of the branch holes opened to the main pipe rail to leave compressive residual stresses in the neighborhoods of openings of the branch holes to relax stress concentration, and then a whole inner peripheral surface of the main pipe rail and the branch holes are subjected to autofrettage processing.

10. The common rail for diesel engines, according to claim 9, wherein the main pipe rail comprises a forging made of a material S45C and having a thick-walled tubular portion.

11. The common rail for diesel engines, according to claim 9, wherein at least peripheral edges of openings of the branch holes are formed with flattened surfaces.

12. The common rail for diesel engines, according to claim 9, wherein branch holes having a predetermined diameter are made in boss portions integral with the main pipe rail to be communicated to the flow passage in the main pipe rail.

13. A common rail for diesel engines, comprising branch holes made in a main pipe rail having therein a flow passage in an axial direction, to be communicated to the flow passage, wherein stress concentration in the vicinity of the branch holes is relaxed by inserting tip ends of branch pipes deeply into the branch holes beyond an inner peripheral surface of the main pipe rail up to an interior of the flow passage and firmly connecting the branch pipes to the main pipe rail, and then a whole inner peripheral surface of the main pipe rail and interiors of connections of the branch holes are subjected to autofrettage processing.

14. The common rail for diesel engines, according to claim 13, wherein the main pipe rail comprises a forging made of a material S45C and having a thick-walled tubular portion.

15. The common rail for diesel engines, according to claim 13, wherein at least peripheral edges of openings of the branch boles are formed with flattened surfaces.

16. The common rail for diesel engines, according to claim 13, wherein branch holes having a predetermined diameter are made in boss portions integral with the main pipe rail to be communicated to the flow passage in the main pipe rail.
